(19) United States
(12) Patent Application Publication
(10) Pub. No.: US 2022/0209640 A1
(43) Pub. Date: Jun. 30, 2022

(54) VIBRATION MOTOR

(71) Applicant: AAC Microtech (Changzhou) Co., Ltd., Changzhou City (CN)

(72) Inventor: Jie Ma, Shenzhen (CN)

(21) Appl. No.: 17/533,151

(22) Filed: Nov. 23, 2021

(30) Foreign Application Priority Data
Dec. 25, 2020 (CN) 202023202848.2

(51) Int. Cl. H02K 33/16; H02K 1/34; H02K 33/18

(52) U.S. Cl. CPC H02K 33/16; H02K 5/04; H02K 33/18; H02K 1/34

(57) ABSTRACT

The present invention provides a vibration motor having a housing body with an accommodation space; a vibration member having a weight with an accommodation cavity, a stator accommodated in the accommodation cavity and spaced apart from the weight. The stator includes an iron core, a coil wound around the iron core, a first damping member and a second damping member. The vibration member further includes a first magnet and a second magnet accommodated in the accommodation cavity. Both the first and second magnets being magnetized in a direction perpendicular to the vibration direction. One of the objects of the present invention is to provide a vibration motor with improved stability of the whole system.

### FIELD OF THE PRESENT DISCLOSURE

The present disclosure relates to motors, in particular to a vibration motor for providing tactile feedback.

### DESCRIPTION OF RELATED ART

With the development of electronic technology, the silent notification of incoming calls of mobile communication terminal devices such as mobile phones need to rely on the vibration of the body to remind the user, and the component that generates the vibration is the built-in vibration motor. In addition, the core components of small medical and health care equipment such as vibrating massagers are also built-in vibration motors. However, the existing vibration motor itself has low damping. In order to improve the stability of the system, additional damping needs to be added to increase the overall damping of the vibration motor.

Therefore, it is necessary to provide a new mechanism to solve the above technical problems.

### SUMMARY OF THE PRESENT INVENTION

One of the objects of the present invention is to provide a vibration motor with improved stability of the whole system.

To achieve the above-mentioned objects, the present invention provides a vibration motor having a housing body with an accommodation space; a vibration member vibrating along a vibration direction, and having a weight with an accommodation cavity; a stator accommodated in the accommodation cavity and spaced apart from the weight.

The stator includes an iron core extending along a direction perpendicular to the vibration direction, a coil wound around the iron core, a first damping member located at one end of the iron core, and a second damping member located at the other end of the iron core.

The vibration member further comprises a first magnet accommodated in the accommodation cavity and located on a side of the first damping member back to the second damping member, a second magnet accommodated in the accommodation cavity and located on a side of the second damping member back to the first damping member. Both the first and second magnets being magnetized in a direction perpendicular to the vibration direction.

In addition, the housing body comprises a first cover plate, a second cover plate opposite to the first cover plate, and a side plate connecting the first cover plate and the second cover plate for forming the accommodation space; the first and second damping members are respectively connected to the first cover plate.

In addition, the first damping member and the second damping member are both sheet structures.

In addition, the first and second damping members are both copper plates.

In addition, the vibration member further comprises a first magnetic frame and a second magnetic frame accommodated in the accommodation cavity; the first magnetic frame is connected to a side of the first magnet back to the first damping member; the second magnetic frame is connected to a side of the second magnet back to the second damping member.

In addition, the first magnetic frame is sandwiched between the weight and the first magnet; the second magnetic frame is sandwiched between the weight and the second magnet.

In addition, the vibration motor further comprises an elastic support suspending the vibration member in the accommodation space; the elastic support is arranged on opposite sides of the weight along the axis of the coil.

In addition, the elastic support comprises two elastic support arms each having a first fixed arm connected to the housing body, a second fixed arm connected to the weight, and an elastic arm connected the first fixed arm to the second fixed arm.

In addition, a side of the elastic arm close to the first cover plate is recessed away from the first cover plate for forming an avoidance part; the vibration motor further comprises a position limiting block corresponding to the avoidance part and located on the first cover plate.

In addition, the stator further comprises a circuit board mounted on the housing body and electrically connected to the coil.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a vibration motor in accordance with an exemplary embodiment of the present disclosure;

FIG. 2 is an exploded and isometric view of the vibration motor in FIG. 1;

FIG. 3 is an isometric view of the vibration motor with a first cover plate thereof removed;

FIG. 4 is an isometric view of the vibration motor with a second cover plate removed;

FIG. 5 is a cross-sectional view of the vibration motor taken along line AA in FIG. 1;

FIG. 6 illustrates how the vibration member works.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

It should be noted that all directional indications (such as up, down, left, right, front, back, inside, outside, top, bottom . . . ) in the embodiments of the present disclosure are only used to explain in a specific posture (such as shown in the figure) the relative positional relationship between the components. If the specific posture changes, the directional indication changes accordingly.

It should also be noted that when an element is referred to as being “fixed on” or “arranged on” another element, the element may be directly on the other element or there may be a centering element at the same time. When an element is referred to as being “connected” to another element, it can be directly connected to the other element or an intermediate element may be present at the same time.

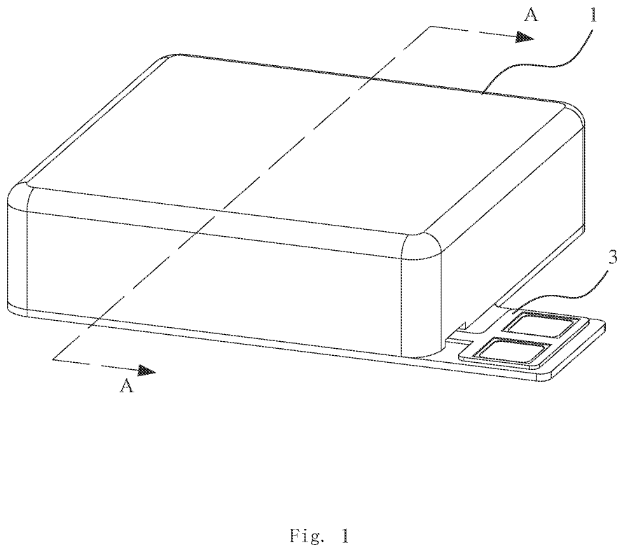

Please refer to FIGS. 1-6 together, the present disclosure provides a vibration motor, which comprises a housing body 1 with an accommodation space, and a vibration member 2 and a stator 3 accommodated in the accommodation space.

Please refer to FIGS. 1-6, the vibration member 2 comprises a weight 21 provided with an accommodation cavity 210. The stator 3 is accommodated in the accommodation cavity 210 and is spaced apart from the weight 21.

The stator 3 comprises an iron core 31, a coil 32 wound on the iron core 31, and a first damping member 33 and a second damping member 34 and a second damping respectively fixed to both ends of the iron core 31 along the direction perpendicular to the vibration direction of the vibration member 2. The first damping member 33 and the second damping member 34 are both fixed to the housing body 1.

The vibration member 2 further comprises a first magnet 22 accommodated in the accommodation cavity 210 and located on the side of the first damping member 33 with its back facing the second damping member 34, a second magnet 23 accommodated in the accommodation cavity and located on the side of the second damping member 34 with its back facing the first damping member 33. Both the first magnet 22 and the second magnet 23 are magnetized perpendicular to the vibration direction.

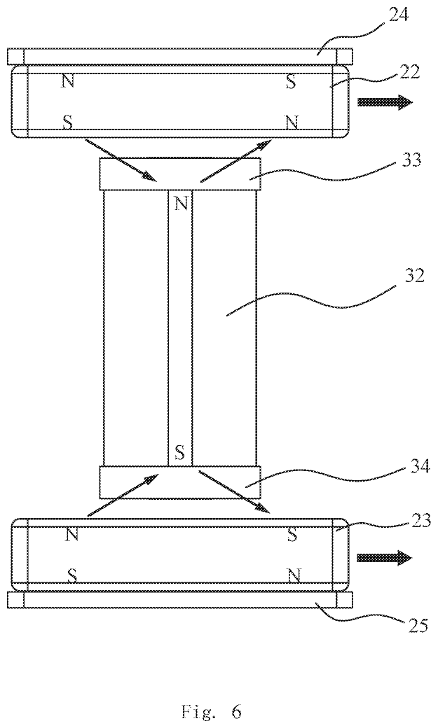

When the coil 32 is energized to polarize the iron core 31, taking the example shown in FIG. 6 as an example, it is assumed that the iron core 31 is polarized so that the end close to the first magnet 22 is the N pole, the end close to the second magnet 23 is the S pole. At this time, the first magnet 22 and the second magnet 23 will receive a rightward driving force in the direction shown in FIG. 6. Under this driving force, the first magnet 22 and the second magnet 23 drive the weight 21 to move to the right, and the movement direction is the vibration direction of the vibration member 2. When the first magnet 22 and the second magnet 23 move to the right, a moving magnetic field is generated. The magnetic field lines of the moving magnetic field respectively cut the damping members (the first damping member 33 and the second damping member 34) located at both ends of the iron core 31. And eddy current is generated inside the damping member, which makes the damping member have damping effect.

Further, because the coil 32 is wound on the iron core 31. The first damping member 33 and the second damping member 34 are fixed on the housing body 1 and respectively fixed on both ends of the iron core 31 along a direction perpendicular to the vibration direction of the vibration member 2. The first damping member 33 and the second damping member 34 can be used to connect the coil 32 and the housing body 1.

In a preferred embodiment, as shown in FIG. 6, the first magnet 22 and the second magnet 23 are both integrally magnetized structures.

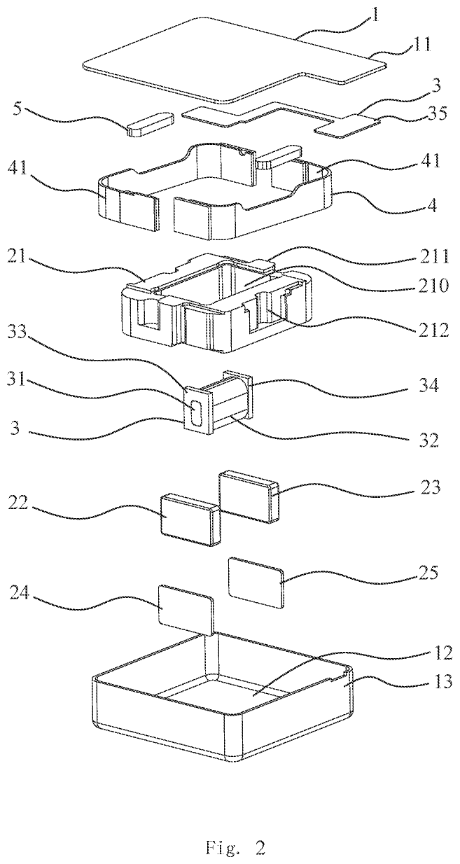

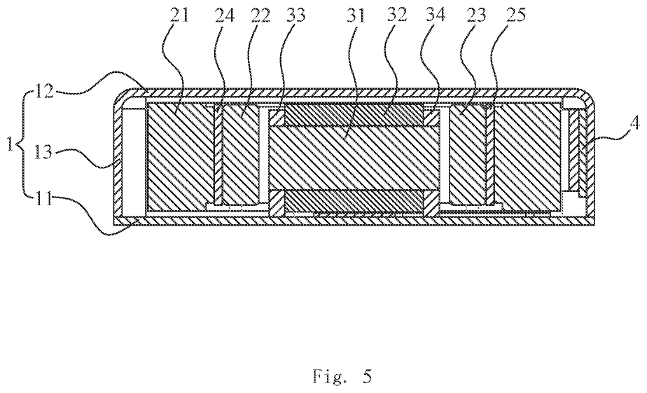

Referring to FIG. 2 and FIG. 5, in a preferred embodiment, the housing body 1 comprises a first cover plate 11, a second cover plate 12 arranged opposite to the first cover plate 11, a side plate 13 connecting the first cover plate 11 and the second cover plate 12. The first cover plate 11 and the second cover plate 12 are connected to the side plate 13 to form an accommodation space. The first damping member 33 and the second damping member 34 are connected to the first cover plate 11 respectively. This way, it realizes the connection between the first damping member 33 and the second damping member 34 with the housing body 1 respectively.

Please refer to FIG. 5 and FIG. 6. In a preferred embodiment, the first damping member 33 and the second damping member 34 are both sheet structures. Preferably, the first damping member 33 and the second damping member 34 are both copper sheets.

Please refer to FIG. 5 and FIG. 6. In a preferred embodiment, the vibration member 2 further comprises a first magnetic frame 24 and a second magnetic frame 25 accommodated in the accommodation cavity 210. The first magnetic frame 24 is connected to the side of the first magnet 22 with its back facing the first damping member 33. The second magnetic frame 24 is connected to the side of the second magnet 23 with its back facing the second damping member 34. When the coil 32 is energized to polarize the iron core 31, the first magnetic frame 24 will move synchronously with the first magnet 22. The second magnetic frame 25 will move synchronously with the second magnet 23.

Please refer to FIGS. 5 and 6. In a preferred embodiment, the first magnetic frame 24 is sandwiched between the weight 21 and the first magnet 22. The second magnetic frame 25 is sandwiched between the weight 21 and the second magnet 23 to form the vibration member 2.

In a preferred embodiment, the vibration motor further comprises an elastic support 4 for suspending and supporting the vibration member 2 in the accommodation space 10 and providing elastic restoring force for the vibration member 2. The elastic support 4 is arranged on opposite sides of the weight 21 along the axis of the coil 32.

The elastic support 4 can stably support the vibration member 2 in the accommodation space 10 when the vibration member 2 vibrates. At the same time, the elastic support 4 can restore the vibration member 2 to the initial position (the position before the vibration occurs) when the vibration member 2 stops vibrating.

Please refer to FIGS. 2-4. In a preferred embodiment, the elastic support 4 comprises two elastic support arms 41 arranged opposite to each other. Each elastic support arm 41 comprises a first fixed arm 411 connected to the housing body 1, a second fixed arm 412 connected to the weight 21, and an elastic arm 413 connecting the first fixed arm 411 and the second fixed arm 412 to form the elastic support arm 41. The weight 21 is located between the first fixed arm 411 and the second fixed arm 412.

The two first fixed arms 411 of the elastic support arm 41 are connected to the housing body 1 respectively. The two second fixed arms 412 of the elastic support arm 41 are respectively connected to the weight 21. The structure of the elastic support 41 and its fixing method to the vibration member 2 and the housing body 1 enable the vibration motor to achieve vibration and improve the performance of the vibration motor.

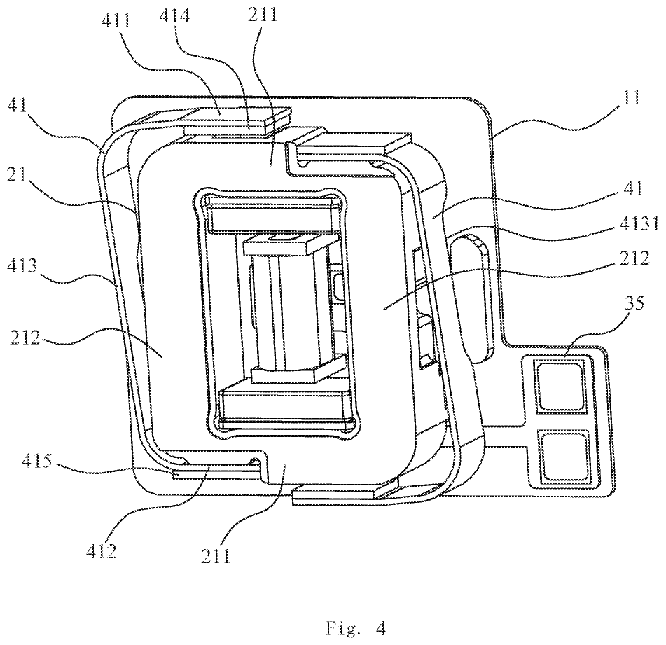

Please refer to FIGS. 2 and 4, in a preferred embodiment, the side of the elastic arm 413 close to the first cover plate 11 sinks away from the first cover plate 11 to form an avoidance part 4131. The vibration motor further comprises a position limiting block 5 arranged on the first cover plate 11. The position limiting block 5 corresponds to the avoidance part 4131. The position limiting block 5 and the avoidance part 4131 are set to match the vibration limit of the vibration member 2.

The elastic support arm 41 also comprises a first welding sheet 414 connecting the first fixed arm 411 and the sidewall 13 and a second welding sheet 415 connecting the second fixed arm 412 and the weight 21. By providing the first welding sheet 414 and the second welding sheet 415, the connection between the elastic support arm 41 and the position limiting block 5 with the housing body 1 is realized.

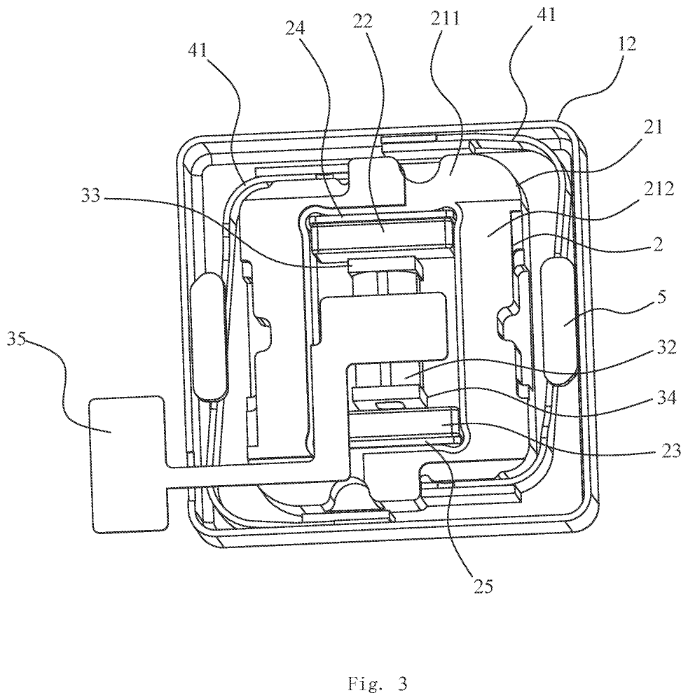

Please refer to FIGS. 3-4, in a preferred embodiment, the weight 21 comprises two first sidewalls 211 arranged in parallel and spaced apart and second sidewalls 212 arranged at both ends of the first sidewall 211 and connected to the two first sidewalls 211. The first sidewall 211 and the second sidewall 212 are connected end to end to form the accommodation cavity 210. The second fixed arm 412 is connected to the first sidewall 211.

The first magnetic frame 24 and the second magnetic frame 25 are respectively connected to the two first sidewalls 211, so that the vibration motor can realize vibration.

Please refer to FIGS. 2-3, in a preferred embodiment, the stator 3 further comprises a circuit board 35 installed on the housing body 1 and electrically connected to the coil 32. The circuit board 35 is used to supply power to the coil 32.

The present disclosure provides a vibration motor. the first damping member 33 and the second damping member 34 are installed on the housing body 1 and are respectively sleeved on both ends of the iron core 31 along a direction perpendicular to the vibration direction of the vibration member 2. The coil 32 is wound on the iron core 31 so that the first damping member 33 and the second damping member 34 can play a role to connect the coil 32 and the housing body 1. In addition, the first magnet 22 and the second magnet 23 are respectively arranged on both sides of the iron core 31. Both the first magnet 22 and the second magnet 23 are magnetized perpendicular to the vibration direction. When the coil 32 is energized, the iron core 31 is polarized so that the first magnet 22 and the second magnet 23 are driven in the same direction along the vibration direction, respectively. Thus, the same direction movement occurs. When the first magnet 22 and the second magnet 23 move, a moving magnetic field is generated. The magnetic field lines of the moving magnetic field cut the damping members (the first damping member 33 and the second damping member 34) located at both ends of the iron core 31. The eddy current is generated inside the damping member, and the damping member has damping effect.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor, comprising:
a housing body with an accommodation space;
a vibration member vibrating along a vibration direction, and having a weight with an accommodation cavity;
a stator accommodated in the accommodation cavity and spaced apart from the weight, comprising:
an iron core extending along a direction perpendicular to the vibration direction;
a coil wound around the iron core;
a first damping member located at one end of the iron core; and
a second damping member located at the other end of the iron core; wherein
the vibration member further comprises:
a first magnet accommodated in the accommodation cavity and located on a side of the first damping member back to the second damping member;
a second magnet accommodated in the accommodation cavity and located on a side of the second damping member back to the first damping member;
both the first and second magnets being magnetized in a direction perpendicular to the vibration direction.

2. The vibration motor as described in claim 1, wherein the housing body comprises a first cover plate, a second cover plate opposite to the first cover plate, and a side plate connecting the first cover plate and the second cover plate for forming the accommodation space; the first and second damping members are respectively connected to the first cover plate.

3. The vibration motor as described in claim 1, wherein the first damping member and the second damping member are both sheet structures.

4. The vibration motor as described in claim 3, wherein the first and second damping members are both copper plates.

5. The vibration motor as described in claim 1, wherein the vibration member further comprises a first magnetic frame and a second magnetic frame accommodated in the accommodation cavity; the first magnetic frame is connected to a side of the first magnet back to the first damping member; the second magnetic frame is connected to a side of the second magnet back to the second damping member.

6. The vibration motor as described in claim 5, wherein the first magnetic frame is sandwiched between the weight and the first magnet; the second magnetic frame is sandwiched between the weight and the second magnet.

7. The vibration motor as described in claim 2, wherein the vibration motor further comprises an elastic support suspending the vibration member in the accommodation space; the elastic support is arranged on opposite sides of the weight along the axis of the coil.

8. The vibration motor as described in claim 7, wherein the elastic support comprises two elastic support arms each having a first fixed arm connected to the housing body, a second fixed arm connected to the weight, and an elastic arm connected the first fixed arm to the second fixed arm.

9. The vibration motor as described in claim 8, wherein a side of the elastic arm close to the first cover plate is recessed away from the first cover plate for forming an avoidance part; the vibration motor further comprises a position limiting block corresponding to the avoidance part and located on the first cover plate.

10. The vibration motor as described in claim 1, wherein the stator further comprises a circuit board mounted on the housing body and electrically connected to the coil.
